(19) United States
(12) Patent Application Publication
(10) Pub. No.: US 2006/0029696 A1
(43) Pub. Date: Feb. 9, 2006

(54) Consumable porous food product covered with a non-porous coating to enable a consumable liquid to be orally drawn in and absorbed

(75) Inventors: William L. Rodman, Ravensdale, WA (US); Loren Michael Greenen, Seattle, WA (US)

Correspondence Address: LAW OFFICES OF RONALD M ANDERSON, 600 108TH AVE, NE, SUITE 507, BELLEVUE, WA, 98004, US

(73) Assignee: Wiiliam L. Rodman, Ravensdale, WA (US)

(21) Appl. No.: 10/913,054

(22) Filed: Aug. 5, 2004

(51) Int. Cl. A23L 1/00

(52) U.S. Cl. 426/89

(57) ABSTRACT

A consumable liquid is orally drawn into a food product and absorbed by an internal structure of the product, before the product is consumed. The product includes a substantially non-porous coating covering its outer surface. In one embodiment, a channel provides fluid communication between spaced-apart openings in the coating, so that when one opening is immersed in a liquid and a reduced pressure is orally applied to the other opening, the liquid is drawn into the channel and absorbed by the internal structure. Another embodiment employs a porous internal structure, or an internal structure comprising open cells, or interstitial spaces to provide fluid communication between the openings. If the food product is completely sealed by the coating, the coating is removed at two points, e.g., by biting away the coating to expose the interior structure. The interior structure can also comprise a dehydrated material, such as dried meat particles.

### FIELD OF THE INVENTION

The present invention generally pertains to edible food products that are able to absorb a liquid, and more specifically, to a consumable, liquid-absorbent food product covered with a non-porous-coating, so that a liquid drawn into the interior of the food product is absorbed.

### BACKGROUND OF THE INVENTION

In addition to being essential for stimulating growth, producing energy, and nourishing and maintaining life, most people would agree that the ingestion of food is definitely one of life's pleasures. The pleasure experienced from eating is not surprising considering that the ingestion of food typically invokes one or more of the primary taste sensations of bitter, sweet, sour, and salty. A fifth taste sensation has also been identified that is called umami, that is characterized by a meaty or savory sensation. Onion-shaped structures known as taste buds convey information about dissolved substances and are located within the fungiform, circumvallate and foliate papillae, the small projections on the tongue. Each taste bud may contain anywhere from 50 to 100 taste cells. Aroma also contributes greatly to our enjoyment of food, and much of what we refer to as the taste of food actually arises from our olfactory sensations.

The pursuit of making food as flavorful, nutritional, and fun to ingest as possible has led to the development of numerous food products designed to combine a flavoring with a beverage and to facilitate sucking the flavored beverage into the user's mouth. For example, U.S. Patent Publication No. 2004/0013772 (Weiss) discloses an edible, nutrient-rich drinking straw for use in consuming beverages. The drinking straw is formed from one or more compressed fruit powders, natural flavor, natural color, and humectant extruded in the shape of a drinking straw. An edible sealing coating such as wax is applied to the exterior of the extruded product. The straw may be formulated with materials selected to dissolve into a beverage at a desired rate and may be formed in a variety of different configurations. However, Weiss' edible drinking straw only imparts a flavor to the beverage or liquid food product as it is drawn into and through the straw and consumed.

U.S. Pat. No. 3,615,595 (Guttag) is directed to a tubular drinking straw having at least a portion of an exposed wall formed of a water insoluble hydroacrylate or methyacrylate polymer. A water soluble flavoring agent is dispersed within the polymer and flavors the liquid drawn into and through the straw. Again, this product functions as a straw, but also adds flavoring to the beverage drawn into the user's mouth through the straw.

Similarly, U.S. Pat. No. 1,996,203 (Hollingsworth) is directed to a straw or tube that is immersed in a glass of water or other liquid. The interior of the straw also includes a coating of soluble flavoring material. When the straw is used to draw a liquid into the user's mouth, the material flavors the liquid. However, both of this and the preceding inventions, like Weiss, are limited in that they only flavor the liquid or beverage that is being drawn into the mouth through the straw.

It is well known that dipping a food product into a consumable liquid or beverage will not only soften the food product but also impart a flavor of the beverage to the food product. Specifically, if a cookie is dipped in a liquid such as milk, the milk will be absorbed into and soften the cookie and make it taste even better. Likewise, if a doughnut is dipped into a liquid, such as coffee, the coffee will soften the doughnut and enhance the doughnut's flavor. Similarly, a cracker or piece of bread dipped in soup will enhance the flavor of the cracker or bread. However, the interior of the cookie, donut, cracker, or bread may not absorb the liquid, since the absorption of the liquid into the food product may be limited due the relatively low pressure tending to force the liquid into the dry food product. Moreover, the dipping of a food product into a consumable liquid is likely to be messy, since the liquid frequently drips from the food product onto the table or the person before the food product is consumed by the person.

Therefore, it would be desirable to provide a food product that more conveniently enables a consumable liquid to be more fully absorbed into the food product and then permits the food to be consumed while minimizing the mess associated with the liquid dripping onto underlying surfaces. It would also be desirable that the food product be made in almost any shape or size and comprise a variety of edible ingredients that absorb a consumable liquid. The portion of the food product that absorbs the liquid should thus be substantially covered with a coating that does not dissolve in the liquid, so that the coating can help in containing the wetted portion while it is subsequently consumed.

### SUMMARY OF THE INVENTION

Recognizing the enjoyment of the taste sensation provided by dipping a food product in a beverage, the present invention was thus developed to enable a user to more effectively achieve that desired combined taste and texture, by more completely exposing the food product to the liquid so that more of the liquid is absorbed within the food product. Unlike a straw that only enables a user to draw a liquid into the mouth (but may also flavor the liquid), the present invention enables a consumable liquid to be orally drawn into the food product and absorbed. The food product includes an interior liquid-absorptive material that is consumable and which is formed so as to provide fluid communication between two spaced-apart points on a surface of the material. Also included is a coating that is consumable and is applied to an outer surface of the interior liquid-absorptive material to substantially seal the material to substantially prevent free entry of air into the interior liquid-absorptive material. The consumable product has thereby been adapted to enable a person to orally apply a reduced atmospheric pressure to one of the two spaced-apart points while the other of the two spaced-apart points is immersed in a consumable liquid, so that a consumable liquid is drawn into and absorbed by the interior liquid-absorptive material.

In one embodiment, the interior liquid-absorptive material comprises a carbohydrate structure that is baked and relatively dry before being exposed to a consumable liquid and thereafter becomes readily wetted by the consumable liquid to which it is exposed. This material can be form in at least three different forms. For example, the material can include a channel that couples the two spaced-apart points in fluid communication, or can comprise a plurality of open cells that are in fluid communication with each other, or can comprise a plurality of interstitial spaces that are in fluid communication. When the channel is used, it extends through the interior liquid-absorptive material, between the two spaced-apart points so that a consumable liquid drawn into the channel is exposed to the material and is thereby absorbed into the material. The interior liquid-absorptive material can also include a granular material having interstitial spaces formed between grains that is absorptive of a consumable liquid to which the material is exposed. As a further alternative, the interior liquid-absorptive material can comprise dehydrated protein particles, such as dehydrated meat particles, that absorb the liquid drawn into the interior of the food product.

As supplied, the food product can be completely covered by the coating, or the two spaced-apart points can be left free of the coating. If the two spaced-apart points are not sealed by the coating, the outer surface of the interior liquid-absorptive material is exposed to the consumable liquid and to the reduced atmospheric pressure at the two spaced-apart points. However, if the two spaced-apart points are sealed by the coating, this coating is removable by a person at the two spaced-apart points to provide fluid communication with a consumable liquid and the reduced atmospheric pressure. For example, the user can simply bite away the coating at the two spaced-apart points, so that the interior liquid-absorptive material is thus exposed.

The coating is resistant to dissolving in a consumable liquid and also does not become tacky when exposed to a consumable liquid for a time sufficient to orally draw the consumable liquid into the interior liquid-absorptive material. Optionally, the coating may include a food flavoring selected to provide a desired flavor for the food product when consumed.

Yet another aspect of the present invention is directed towards a method for producing a consumable food product like that just described. The method includes the step of producing an internal structure that is consumable and formed so as to provide fluid communication between two spaced-apart points on a surface of the structure. The method also includes the step of substantially sealing an outer surface of the structure with a layer that is consumable, to substantially prevent free entry of air into the structure and to enable a person to orally apply a reduced atmospheric pressure to one of the two spaced-apart points while the other of the two spaced-apart points is immersed in a consumable liquid, so that a consumable liquid is drawn into and absorbed by the structure. The layer also helps to retain a consumable liquid that was absorbed by the internal structure, within the food product as the food product is consumed.

Finally, the invention is also directed towards a method for using a consumable food product that enables a consumable liquid to be orally drawn into and absorbed by the food product. This method includes the steps of positioning the consumable food product so that one of two spaced-apart points on a surface of the consumable food product is immersed in a consumable liquid. The method also includes the step of orally applying a reduced atmospheric pressure to the other of the two spaced-apart points so that the consumable liquid is drawn into and absorbed by an interior material of the food product, without requiring that the consumable liquid be drawn into a user's mouth, but so that the food product is enhanced by absorbing the consumable liquid.

If a coating covers the two spaced-apart points, it is removed, so that an outer surface of the interior material is accessible to fluid communication with the consumable liquid and with the reduced atmospheric pressure at the two spaced-apart points.

The consumable liquid should have a viscosity sufficiently low so that a user is able to draw the consumable liquid into the interior material by orally applying the reduced atmospheric pressure at one of the two spaced-apart points on the food product.

The consumable food product can be employed to absorb a beverage, soup, a sauce, or other appropriate liquid. The food product is then preferably consumed after it has absorbed the consumable liquid.

### BRIEF DESCRIPTION OF THE DRAWING FIGURES

The foregoing aspects and many of the important advantages of this invention will become more readily appreciated as the same becomes better understood by reference to the following detailed description, when taken in conjunction with the accompanying drawings, wherein:

FIG. 1 schematically illustrates a longitudinal cross-sectional of a food product in accord with the present invention being used to orally draw a consumable liquid into an interior of the food product, where the liquid is absorbed;

FIG. 2 is a longitudinal cross sectional view of another embodiment of the food product that is elongate in shape and that uses a channel formed in the interior to enable a consumable liquid to be drawn into and absorbed by interior structure of the food product;

FIG. 3A is a cross sectional view of a third embodiment of the food product that is generally round in shape, is initially fully sealed with a coating, and has an internal structure with interstitial spaces that absorb a consumable liquid;

FIG. 3B is a cross sectional view of the third embodiment after portions of the coating have been removed (i.e., by biting the coating away) at two spaced-apart points;

FIG. 3C is a cross sectional view of the fourth embodiment of the food product that is elongate in shape and has an internal structure with a plurality of interstitial spaces that absorb a consumable liquid orally drawn into the interior of the food product;

FIG. 4A is a cross sectional view of a fifth embodiment of the food product that is generally square-shaped and that has an internal structure with a plurality of open cells that provide fluid communication between two spaced-apart sides, so that a consumable liquid can be drawn into and absorbed by the open cells of the food product; and

FIG. 4B is a cross sectional view of the fifth embodiment with a mix of open cells and closed cells.

### DESCRIPTION OF THE PREFERRED EMBODIMENT

Overview of the Food Product

The present invention is usable to orally draw a consumable liquid into the interior of a consumable food product, where the liquid is absorbed by the material comprising the interior, so that the food product can then be consumed. As a result, the taste of the food product is combined with that of the liquid, and the texture of the food product is softened by the liquid. The food product is also fun to use since a user may immerse an open portion (free of a coating) of the consumable food product into a consumable liquid, orally apply sufficient suction to another open portion of the food product, and draw the consumable liquid into the interior of the food product. Because the interior is either relatively porous, or includes open cells, or interstitial spaces, the liquid is readily absorbed, and the reduced atmospheric pressure applied orally at one point is communicated to another point on the surface of the food product that is immersed in the liquid, so that the liquid is fully drawn into the interior portion. The coating or covering seals the rest of the food product so that air is not drawn through the surface above the liquid, which would prevent the liquid from being drawn into the interior.

Once the interior structure of the food product is relatively saturated with the liquid, the user then consumes the food product, whose flavor is enhanced by the consumable liquid that has been absorbed into its interior.

As noted above, the interior of the food product must be sufficiently porous or open so that a reduced atmospheric pressure orally applied at one point on the surface of the food product can draw a liquid into another point that is immersed in the liquid, and the porosity should be sufficient to absorb a desired quantity of the consumable liquid when the liquid is thus drawn into the interior of the food product. As originally sold, the food product may be completely sealed by an outer coating such that the user needs to remove the coating from two points that are spaced-apart on the outer surface of the food product before submerging one point in the consumable liquid. In the alternative, the food product may be sold with the two points that are spaced-apart on the outer surface of the food product already free of the coating, such that user does not need to create these two openings before using the food product.

A sweet tasting, consumable food product will likely be a popular choice for the present invention. For example, the interior of this form of the food product may be either a porous honey graham or vanilla flavored, sweetened dough that is baked and then covered with a chocolate, yogurt, or sugar coating that complements the porous, sweetened interior. One preferred combination is a chocolate coating and the honey graham sweetened porous interior structure. Another preferred combination is the yogurt coating and the porous vanilla flavored, sweetened interior structure. The sugar coating should complement either the honey graham or the vanilla structure. Of course, various combinations of these and other coatings and internal structures can be made, depending on the user's tastes.

One portion of this food product that is not coated can then be dipped in a beverage, such as coffee, cocoa, or milk. When the user applies oral suction to the other portion that is not coated, the beverage is drawn up into the interior porous structure of the food product and absorbed. The user may then consume the food product, which can serve as a dessert or as a snack. It is contemplated that low fat ingredients or sugar-free formulations might also be made in order to satisfy consumers' dietary restrictions.

Instead of consuming beverages, this invention may be used with soups and broths that are orally drawn into the interior of the food product and absorbed to enhance the flavor of the food product. The interior of such an embodiment of the food product may comprise a dehydrated shredded or diced meat or other protein encased within a baked biscuit dough that is covered with an egg white coating. One portion that is not covered by the egg white coating is then dipped into a favorite soup. When the user orally applies suction to another portion of the food product that is not covered by the egg white coating, the soup is drawn into the biscuit material and absorbed by the dehydrated meat in the interior. The dehydrated meat is at least partially rehydrated by the soup, which enhances the flavor of the rehydrated meat and of the food product in general.

A still further alternative choice for the food product that might be particularly attractive to the frustrated parent of children who are finicky eaters may employ a baked bread internal structure that includes pieces of broccoli and carrots or other nutritional vegetables baked into the bread, which is then coated with broiled cheese. This food product could also include a favorite dehydrated meat encased by the baked bread internal structure, and the baked bread can then be coated with broiled cheese. This form of the food product in accord with the present invention would probably be very enticing to children who are instructed to first bite off two opposite ends (or sides) of the food product, thereby exposing the interior to enable the soup to be drawn into the interior by applying oral suction to another end where the interior structure is exposed.

The present invention may also be particularly appealing to people who are experiencing gum or tooth pain and are seeking softer foods to consume. Such a user can allow more time to elapse after orally drawing the liquid into the interior of the food product, before consuming the product, so that the interior structure of the food product is more softened and is therefore easier for the user to chew.

Method of Use

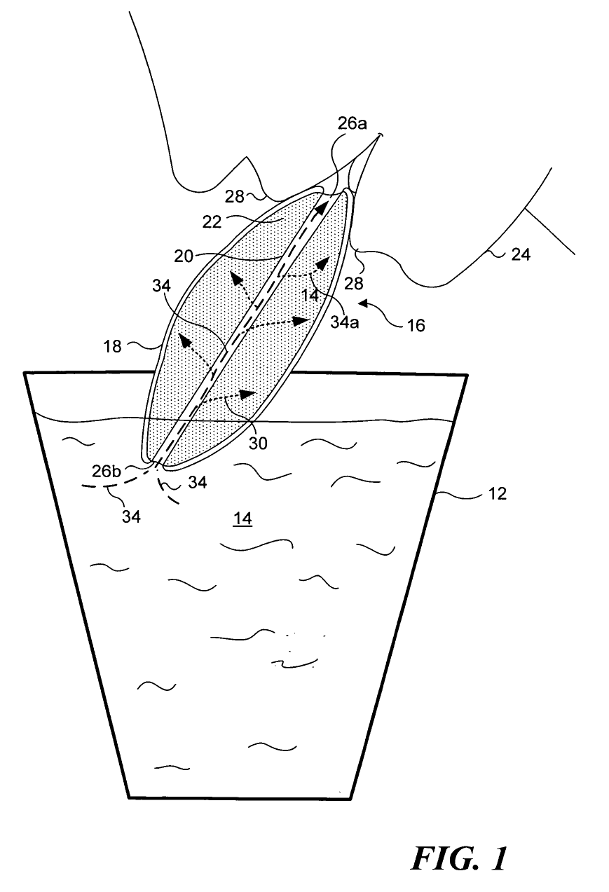

FIG. 1 schematically illustrates how a consumable food product 16 in accord with the present invention is used to orally draw a consumable liquid 14 into the interior of the food product. A user 24 has partially submerged food product 16 in consumable liquid 14, which is held in a container 12. Lips 28 of user 24 are sealed around food product so that the user can orally apply a suction to food product 16 at an orifice 26a, where the outer surface of the food product is also free of a coating 18. Consumable liquid 14 is drawn into the food product through a second orifice 26b disposed at the opposite end and also free of coating 18 and absorbed by porous interior material 22.

Container 12 may be a glass, as shown in the example of FIG. 1, or a coffee cup, bowl, or any other vessel that can hold a consumable liquid and provide sufficient depth to partially submerge food product 16 within the consumable liquid.

Consumable liquid 14 may be any consumable liquid that has a viscosity sufficiently low so that it can be drawn into food product 16 through the fluid communication provided between the spaced-apart points that are free of the coating. Fluid communication is established when at least two points on the surface of the food product are free of the coating such that one point where access to the porous interior material is provided can be submerged into a liquid, and when suction is orally applied to the other point, the liquid is drawn into and absorbed into the interior porous material. Consumable liquid 14 may be a beverage, a soup, or a sauce. Those skilled in the art will recognize that many other liquids could be used for the consumable liquid, including but not limited to, soft drinks, coffee, milk, milkshakes, juices, tea, beer, wine, and liquor. The present invention can be used with any of these liquids, regardless of their ingredients, so long as the liquids are of sufficiently low viscosity, as explained above. Even if a broth, soup, or sauce contains some food component that is not in liquid form, such as a vegetable or chicken soup that contains portions of solid vegetables, noodles or rice, and meat, those skilled in the art will understand that the liquid portion of the vegetable or chicken soup can still serve as the consumable liquid with which the present invention is used.

When user 24 orally applies sufficient suction to orifice 26a of the food product, consumable liquid 14 is drawn into the interior of the food product by way of a central channel 20 that provides fluid communication to convey the consumable liquid along the center of the food product from the submerged portion of food product 16, through orifice 26b. The central channel extends longitudinally from the submerged orifice, through the food product, to orifice 26.

Dash line arrow 34 indicates the path along which consumable liquid 14 flows into central channel 20. The liquid readily penetrate the walls of central channel 20 and is absorbed by a porous interior material 22 comprising the interior structure of the food product. Dotted line arrows 34a indicate the general path followed by the liquid as it is absorbed by the porous interior material.

The outer surface of porous interior material 22 is covered with coating 18 (except over orifices 26a and 26b) so that air does not freely pass through the outer surface of the porous interior material, which would substantially reduce the suction that is orally applied and possibly prevent liquid from being fully drawn up into central channel 20. In addition, coating 18 helps to retain the consumable liquid absorbed within porous interior material 22, as the food product is being consumed. This porous interior material is relatively dry and free of moisture before use.

Coating 18 may be any substantially non-porous edible food component, such as chocolate, sugar, yogurt, fractionated palm kernel oil and butter, egg white, hardened gelatin, marzipan, glaze, broiled cheese, icing, sugar glaze, or candy that is applied to the outer surface of the porous interior material. The non-porous coating can be made of any number of edible ingredients as long as the coating resists dissolving and melting away when the food product is immersed in consumable liquid 14—at least for a reasonable time after the liquid is absorbed by the interior material. Also, for at least the time that coating is immersed in the liquid, the coating should not become tacky to the touch or melt. Thus, when user 24 submerges consumable food product 16 in consumable liquid 14, coating 18 must not dissolve immediately and melt away or stick to the user's fingers or hand. The thickness of the coating necessary to prevent its ready dissolution upon submersion in a liquid will vary depending upon the selected coating ingredients, the nature of the liquid, and the temperature of the liquid.

Depending on the absorptive characteristics of the interior structure of food product 16, it is possible that as consumable liquid 14 is drawn into the food product and absorbed as shown by the general path indicated by dotted line arrows 34a, that some consumable liquid 14 may exit through orifice 26. Even if user 24 imbibes some of consumable liquid 14, the intended function of the food product is not to server as a straw to draw the consumable liquid 14 into the user's mouth, but instead, to draw the liquid into the interior of the food product so that the liquid is absorbed into porous interior material 22, thereby enhancing the flavor and texture of food product 16 when the food product is subsequently consumed.

Furthermore, it is likely that a coating will be selected that provides a desired food flavoring appropriate to the liquid being absorbed by the food product. For example, yogurt, chocolate, marzipan, or a sugary glaze or icing may be selected to coat a sweet food product. A cheese-based coating, or an egg white coating may be applied to a bread-like porous interior material that includes vegetables or meat. Of course, it may be desirable to coat the porous interior material of the sweet food product with a sour flavored coating to achieve the desired flavor. Those skilled in the art will also note that more than one coating may be selected and applied to the food product. For example, a chocolate coating that seals the porous interior material of a sweet food product may then be covered with an outer layer comprising a vanilla-flavored coating. Moreover, a filling might be inserted between the chocolate and vanilla coatings.

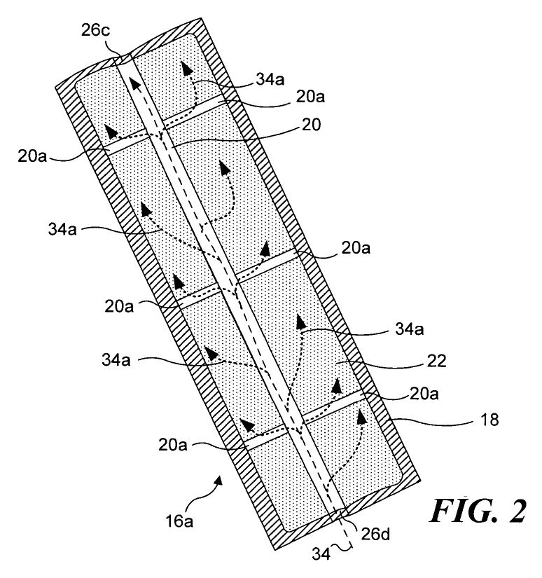

Unlike the porous internal material of the first embodiment discussed above, the internal material used in the food product may be formed to have open cells or interstitial spaces, or may comprise dehydrated material that readily absorbs a liquid. These other embodiments, which provide fluid communication between the two spaced-apart points other than through a porous material, or along an internal passage coupling two orifices, are discussed below in detail in connection with FIGS. 2, 3A, 3B, 3C, 4A, and 4B.

### First Embodiment

FIG. 2 illustrates a cross-sectional view of an embodiment of a food product 16a that also includes an internal channel 20 and is shaped as an elongate cylinder. The internal cylinder enables a user to orally apply a suction at one end to draw a consumable liquid into the opposite end, so that the consumable liquid is absorbed into porous interior material 22 of food product 16a. Internal channel 20 couples orifice 26a and orifice 26b in fluid communication, as in the first embodiment that is shown in FIG. 1. When the consumable liquid is drawn into the internal channel along the path indicated by dash line arrow 34, the porous interior material is exposed to the consumable liquid, which is readily absorbed into the porous interior material, as indicated by dotted line arrows 34a. When food product 16a is sold, orifices 26a and 26b are not covered by coating 18. Thus, the user does not have to unseal these orifices before using the food product with a consumable liquid. Porous interior material 20 can alternatively comprise interstitial spaces, or can be open cell, or can comprise dehydrated material that readily absorbs a liquid. If sufficiently porous or open cell internal material is used for food product 16a, internal channel 20 can be omitted.

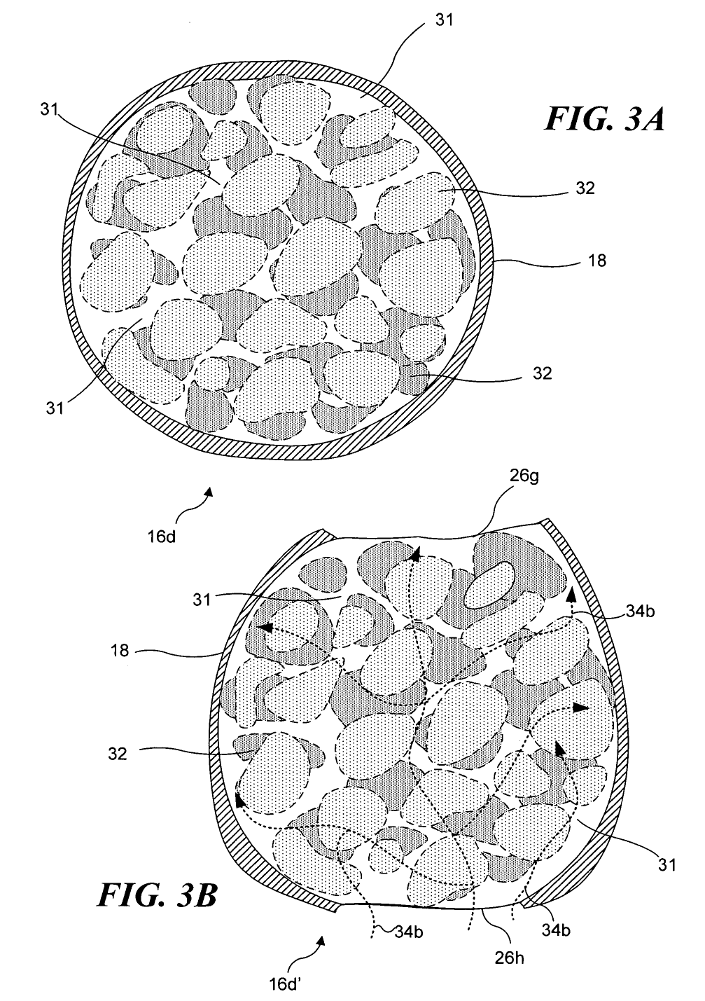

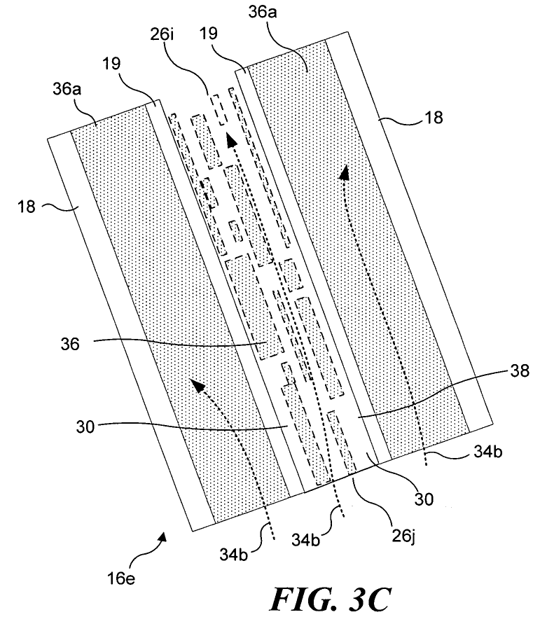

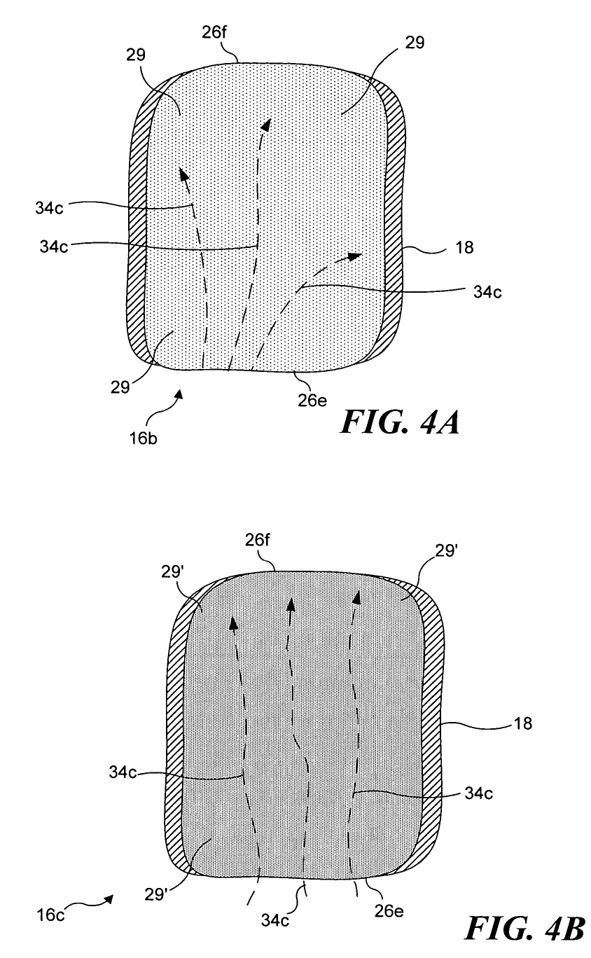

The food product in accord with the present invention can be of any shape or size that is practical to handle and use with a consumable liquid, so that the liquid is drawn into the food product and absorbed therein. Therefore, the elongated, square-shaped and circular-shaped food product examples depicted in FIG. 2, FIG. 3A, FIG. 3B, FIG. 3C, FIG. 4A, and FIG. 4B, are merely three of the many different shapes in which the food product can be formed. The exemplary formulas set forth were used to prepare an embodiment that includes an internal channel and having an approximate length of 6 inches, but this length can vary, since the food product need only be as long as desired to absorb sufficient consumable liquid to impart the flavor of the consumable liquid to the food product.

Those skilled in the art will also recognize that more than one internal channel can be formed within the food product to provide the path for the consumable liquid to be orally drawn into and absorbed by the interior material comprising the food product. Also, the internal channels that are formed in the food product need not extend only longitudinally between opposite ends of the food product, but can instead, extend radially adjacent an end or side of the food product (not shown). However, although food product 16a (and other embodiments discussed herein) can be configured to employ more than one internal channel and more than two orifices, those skilled in the art will recognize that the an orifice formed in the food product and coupled to an internal channel must either be sealed by a user's mouth, lips, and/or tongue, or must be submerged below the surface of the consumable liquid to enable the consumable liquid to be effectively be drawn into the internal channel. If one orifice that is coupled to a fluid channel and covered by a user's mouth is in fluid communication via the internal channel with another orifice that is not submerged, air will be drawn into the internal channel through that orifice instead of the consumable liquid.

Those skilled in the art will also recognize that additional internal channels 20a can be formed within the food product to assist in conveying the consumable liquid to the porous interior material. Such internal channel would not have an orifice open to the outside air, i.e., are covered with coating 18 and are located so as to branch off from the primary channel. Hence, depending on the ingredients of the porous interior material and the number of channels with and without orifices, the absorption rate of the liquid will vary. However, the absorption rate should be sufficient so that the interior material is flavored within a reasonable time after submerging one orifice of the food product in the liquid and orally applying suction to the other orifice.

Furthermore, coating 18 must substantially seal porous interior material 22, to prevent air from freely being drawn into the interior material when an oral suction is applied by the user, which would interfere with the consumable liquid being drawn into the interior of the food product and absorbed. In addition, the coating seals the liquid absorbed in the food product, so that to the liquid generally does not drip from the food product as the food product is consumed after the liquid is absorbed therein.

Two examples of food products using the internal channel are discussed in detail below. One of these examples has a honey graham porous interior material 22 and is coated with a chocolate material for coating 18. The second example of this embodiment of the food product has a vanilla porous interior material 22 and is coated with a yogurt coating for coating 18. In the alternative, a sugar glaze may be used for coating 18 in both of these examples.

### Embodiment Having Interstitial Spaces and No Internal Channel

FIG. 3A illustrates an embodiment of a food product 16d that is circular in shape and which absorbs a consumable liquid (not shown) into interstitial spaces 31 formed between a granular material 32 comprising the internal porous material. This embodiment also includes coating 18, which initially covers the entire outer surface of the food product. FIG. 3A represents the interstitial spaces schematically, and is not intended to depict these spaces and granular material as they truly appear.

Unlike the first and second embodiments, food product 16d, a cross-sectional view of which is shown in FIG. 3A, does not include an internal channel formed through the interior between two opposite ends. Also, because the coating completely covers the outer surface, effectively sealing the interior of the food product, in order to enable fluid communication with the interior for the user's mouth and for the consumable liquid to flow into the interior, the coating must be removed from two spaced-apart points on the food product. There are several ways in which the coating can be removed in this manner. For example, the food product may be perforated at opposite sides, to indicate where the portions of the coating are to be torn away by the user. For example, a line of indentations could mark the portions of the coating to be removed, so that the user would know exactly where to break off portions of the food product in order to create the free access to the interior material of the food product. Alternatively, the user may simply bite off the coating at two opposite sides or edges of the food product so that one side with the internal material thus exposed can be submerged in the consumable liquid and the other side can have oral suction applied to it. Either of these techniques for unsealing the food product may be particularly appealing to younger people.

FIG. 3B illustrates a food product 16d′ after one of the above methods has been applied to the consumable food product to produce openings 26g and 26h in coating 18, at opposite edges. Once opening 26h has been submerged in a consumable liquid (not shown) and suction has been orally applied to opening 26g by the user, the consumable liquid will flow through interstitial spaces 31 formed between granular material 32, as indicated by dotted line arrows 34b. As the consumable liquid is drawn into consumable food product 16d′, it is absorbed into the interior material of the food product and retained within the interstitial spaces.

Granular material 32 is illustrated with two different shadings to indicate that is distributed in layers throughout the interior of food products 16d and 16d′, so that interstitial spaces 31, which are formed between the granules, can readily absorb the liquid that is orally drawn into the interior of the food product. The granular material may comprise, for example, chocolate chips, nuts, or vegetable matter that does not itself absorb liquid. However, the interstitial spaces between these granules readily hold a consumable liquid due to capillary forces, so that the liquid is effectively absorbed by the internal material of the food product.

FIG. 3C illustrates a schematic cross-sectional view of a portion of an embodiment of a food product 16e, which has a plurality of generally longitudinally extending interstitial spaces formed between elongate particles 36 of dehydrated meat (or of other dehydrated material) comprising a core 38. Food product 16e also includes a biscuit porous interior material 36a surrounding core 38, into which a consumable liquid (not shown) can be orally drawn and absorbed. Examples of elongate particles 36 of dehydrated meat include dried beef, chicken, or fish, as discussed below. Those skilled in the art will appreciate that dehydrated vegetable and fruit particles are alternative substitutes for the meat particles. Dried meat and other dehydrated material tend to reabsorb liquid when exposed to it. Also, biscuit porous interior material 36a is sufficiently porous to enable liquid to be drawn and absorbed. Coating 18 in this example comprises an egg white wash. However, as discussed below, it was discovered that using the egg white wash as a secondary coating 19 aids in helping elongate particles 36 of dehydrated meat adhere to biscuit porous interior material 36a and reduces the absorption rate of consumable liquid into biscuit porous interior material 36a so that it does not become unstable.

To use food product 16e, an orifice 26j formed at one end of core 38 is submerged in a consumable liquid (not shown) such as a soup or broth, and a suction is orally applied to an orifice 26i formed at an opposite end of the core. The consumable liquid is drawn through interstitial spaces 31 within core 38, as indicated by dotted line arrows 34b. As the consumable liquid is drawn into core 38 of consumable food product 16e, elongate particles 36 of dehydrated meat reabsorb the consumable liquid, thereby becoming rehydrated and expanding. In addition, biscuit porous interior material 36a absorbs the liquid. The food product can then be consumed, and the user will enjoy the flavor of the dehydrated meat along with that of the soup or broth, as well as enjoy the somewhat softer texture of the rehydrated material.

### Fourth Embodiment

FIG. 4A illustrates a cross-sectional view of an embodiment of a food product 16b that is square-shaped and includes an open cell interior material 29 for providing fluid communication between spaced-apart openings 26e and 26f, such that a consumable liquid (not shown) can be orally drawn into and absorbed into the open cell material. Dash line arrows 34c schematically depict flow of the consumable liquid between the open cell walls. Coating 18 covers the food product, except at ends 26e and 26f such that liquid can orally be drawn into consumable food product 16b through one end that is submerged in a liquid (not shown), when a reduced atmospheric pressure is orally applied to the other end. The open cell structure inside food product 16b readily absorbs the liquid that is thus drawn into the material. Note that the liquid does not have to follow a particular pathway.

It will be apparent that food product 16b can be formed in many different sizes, shapes, and can have larger or smaller open cells. No attempt has been made to faithfully depict the open cells of the open cell interior material, since such cells are typically relatively small and irregular.

Alternatively, a food product 16c, can be formed, as shown schematically in FIG. 4B, in which some of the cells are closed. However, sufficient numbers of open cells comprise an interior material 29′ so that the consumable liquid can still be orally drawn into along paths represented by dash line arrows 34c and absorbed. Moreover, it will be appreciated that a combination of channels and interior material 29 or 29′ can be employed to facilitate orally drawing the consumable liquid into the interior, where the liquid is readily absorbed by interior material 29′, even if a substantial portion of the cells comprising the material are closed.

Method of Preparation

The following exemplary formulas and findings resulting from experimental development of the food product illustrate its method of preparation. Formulas for a honey graham and vanilla porous interior materials are described below. Also discussed below are formulas for chocolate, yogurt, and sugar coatings. In addition, a formula for the embodiment having the dehydrated meat particles and biscuit porous interior material with an egg white coating is included.

To achieve appropriate consistency and porosity of the honey graham and vanilla porous interior materials such that the consumable liquid can be drawn into an exemplary six inch long internal channel that was used in this example, a flour having an increased fiber content was employed. Use of a graham flour in the honey graham porous interior material preparation and inclusion of a whole-wheat flour in the vanilla porous interior material preparation ensure structural integrity of the resulting interior material after baking.

Because the honey graham material is based on a biscuit formula, overworking the flour causes too much gluten development, resulting in the material being too dense. Rolling the material in additional graham flour after an extrusion process aids in retention of the channel within the material by helping to dry the outer surface sufficiently so that it holds the desired shape. Without the graham flour, the material does not hold its shape when submerged in the consumable liquid during use.

The vanilla material is based on a standard creaming method that produces too fragile a porous interior material when baked. Accordingly, to increase the strength of the material, its gluten content is developed slightly more than would be desired for a conventional food product, by providing additional mixing. The additional mixing also helps the material hold the shape of the internal channel and increases porosity such that the material remains stable when immersed in the consumable liquid during use.

Prior to applying the coating, it was found that the outer surface of the porous interior material needs to be relatively free of crumbs or flour. The coating more readily adheres to the surface when the surface is clean.

Furthermore, in order to ensure that chocolate and yogurt coatings can be handled with minimal melting and adherence to the user's fingers and without requiring tempering, it is preferable to incorporate fractionated palm kernel oil in the coatings. Also, both coatings work well for hot consumable liquid applications, melting slowly enough to enable the food product to be used to orally draw the hot liquid inside the food product and then consumed. Both coatings need to be thinned to the consistency of a very thick flowing cream, to achieve appropriate coating thickness.

Preparation of the sugar coating includes boiling sugar syrup; corn syrup is preferably used in order to control crystallization and decrease the brittleness of the hardened sugar. Also, the corn syrup formula can be cooled slightly while remaining viscous enough to coat the porous interior material. With hotter syrup, the porous interior material cooks further and tends to soften, making it difficult to handle the porous interior material without it breaking up.

To achieve appropriate consistency and porosity for the dehydrated meat particle that is used with the biscuit porous interior material, and with the egg white coating, it is necessary to increase the fiber content of the flour and decrease the shortening or fat content. Use of whole wheat flour and adding no other fat than that available in the milk and egg results a firm, dry pliable biscuit dough that is stable once submerged in a hot consumable liquid. Application of the egg white coating between the dehydrated meat particle core and the biscuit porous interior material helps the meat particles in the core to adhere to the biscuit porous interior material.

The following formulas demonstrate an example of an embodiment of the food product with an internal channel formed in the porous interior material and baked once it has been extruded from dough. Those skilled in the art will recognize that the porous interior material may also be prepared using a molding process followed by baking the porous interior material.

Exemplary Formula for Honey Graham Porous Interior Material With Internal Channel

Ingredient List—All ingredients are listed by weight unless otherwise noted and are at about 70° F. ambient temperature, unless otherwise noted.

| | | | |
|---|---|---|---|
| 1 | Milk, whole, liquid | 2.5 | oz |
| 2 | Honey | 2.75 | oz |
| 3 | Flour, graham | 8.5 | oz |
| 4 | Flour, all-purpose | 4.5 | oz |
| 5 | Sugar, golden brown | 2.75 | oz |
| 6 | Baking powder | 1.25 | tsp |
| 7 | Baking soda | .5 | tsp |
| 8 | Salt, fine | .25 | tsp |
| 9 | Butter, unsalted, 36° F. | 3 | oz |
| 10 | Shortening, vegetable, non-hydrogenated | 1.5 | oz |
| 11 | Flour, graham | 4.5 | oz |

Procedure
Mix together milk and honey (1-2) until fully incorporated and set aside.
Sift together 3 times all dry ingredients (3-8). Must be completely mixed.
Cut in butter and shortening (9-10) until a fine sand texture is formed.
Make well in center and pour in liquid mixture.
Lift the dry mixture through liquid mixture until a moist, very loose dough is formed and has the texture of wet sand. The dough should not be kneaded or over mixed and should be used immediately.
Evenly spread graham flour on cutting board.
Fill metal screw-type spritz cookie maker, fitted with a ½-inch diameter opening extrusion tip, with the dough.
Extrude the dough at a rate of about 2 inches per second (i.e., requiring 6 seconds for 12 inch segments) onto the graham floured board.
Cut extruded dough into 6-inch lengths.
Roll extruded dough in graham flour without using pressure on formed dough.
Lift extruded dough onto double sheeted, heavy gauge aluminum ½ sheet pans.
Bake at 350° F. in convection oven for 13-15 minutes until firm to touch and color changes to golden brown.
Remove from oven and roll extruded dough 180° to help round formation. Leave on baking sheet.
Once baked dough is cool enough to touch, move to a rack until fully cooled.
Brush Graham flour off with soft cotton towel or pastry brush.
   Equipment Summary
Scale
Mixing bowls—1 quart, 4 quart
Whisk
Sifter
Knife
Cutting board
Spritz cookie press—metal, screw-type
Extrusion tip—½ inch diameter opening
Spatula
Heavy gauge aluminum baking sheet pans
Oven—convection, dry
Cooling rack
Tongs
   Exemplary Formula for Vanilla Porous Interior Material with Internal Channel

Ingredient List—All ingredients are listed by weight unless otherwise noted and are at an ambient temperature of about 70° F., unless otherwise noted.

| | | | |
|---|---|---|---|
| 1 | Flour, all-purpose | 7.5 | oz |
| 2 | Flour, whole wheat | 4.5 | oz |
| 3 | Salt, fine ground | .5 | tsp |
| 4 | Butter, unsalted | 3.75 | oz |
| 5 | Shortening, all-vegetable | 2.75 | oz |
| 6 | Sugar, fine granulated | 5 | oz |
| 7 | Vanilla, natural | .33 | oz |
| 8 | Eggs, whole | 3.5 | oz |

Procedure
Sift together flours and salt (1-3) three times until well mixed and set aside.
Cream the butter, shortening, and sugar (4-6) together with paddle until there is no gain in mixture.
Add vanilla (7) and mix until incorporated.
Add each egg (8) one at a time until each is fully incorporated, being careful not to mix-in air.
Add flour mixture to creamed mixture and fully mix with paddle on low speed, until fully incorporated.
Mix on low speed for one additional minute to develop into a soft dough.
Fill metal screw-type spritz cookie maker, fitted with a ½-inch diameter opening extrusion tip, with the dough.
Extrude the dough at a rate of 2.5 inches per second (i.e., requiring about 5 seconds for 12 inch segments) onto heavy gauge aluminum ½ sheet pans.
Bake at 350° F. temperature in convection oven for about 12 minutes, until firm to touch and until the color of edges changes to a golden brown.
Remove from oven. Leave on baking sheet.
Once cool to touch, move the baked interior materials to rack until fully cooled.
   Equipment Summary
Scale
Mixing bowls—1 quart, 4½ quart
KITCHENAID™ mixer with 250-watt motor
Sifter
Knife
Spatula
Cutting board
Spritz cookie press—metal, screw-type
Extrusion tip—½ inch diameter opening
Heavy gauge aluminum baking sheet pans
Oven—convection, dry
Cooling rack
Tongs
   Exemplary Formula for Chocolate Coating for Honey Graham Porous Interior Material with Internal Channel

Ingredient List—All ingredients are listed by weight unless otherwise noted and are at an ambient temperature of about 70° F., unless otherwise noted.

| | | | |
|---|---|---|---|
| 1 | Chocolate coating | 12 | oz |
| 2 | Crystal flakes | 0.5 | oz |

Procedure
Melt coating chocolate and crystal flake (1-2) over warm water (150°-160° F.) in large flat pan, sufficiently wide to accommodate 6 inch porous interior materials.
Roll the porous interior materials in the melted chocolate until evenly coated.
Place coated porous interior material on SILPAT™ baking pad and refrigerate to shock chocolate, setting and hardening the coating.
Thoroughly cool porous interior material until chocolate is fully hardened.
Store in cool location (under 70° F. ambient temperature) in sealed container.
   Equipment Summary
Spatula
Heavy gauge aluminum baking sheet pans
Silicon tipped tongs (chocolate tongs)
Double boiler with wide pan
SILPAT™ silicone pad to fit ½ sheet pan
Refrigerator at 34°
Sealed storage container
   Exemplary Formula for Sugar Coating

Ingredient List—All ingredients are listed by weight unless otherwise noted and are at an ambient temperature of about 70° F., unless otherwise noted.

| | | | |
|---|---|---|---|
| 1 | Sugar, fine granulated | 15 | oz |
| 2 | Corn syrup, light | 11.75 | oz |
| 3 | Water | 8 | oz |

Procedure
In a heavy gauge non-reactive saucepan combine all ingredients until well mixed.
Heat to about 300° F.-310° F. and remove from heat and allow to cool to 280° F.-290° F. temperature.
Holding each porous interior material lengthwise between tongs, dip in prepared syrup solution.
Lift immediately after coating and let excess syrup solution drip off for 1 to 2 seconds.
Place on SILPAT™ baking pad sized to fit in ½ sheet pan, to harden.
Store in cool place (under 70° F. ambient temperature), in an airtight container with de-humidifying packet to retain freshness.
   Equipment Summary
Heavy gauge non-reactive saucepan
Wooden spoon
Candy thermometer
Heavy gauge aluminum baking sheet pans
Metal tongs
SILPA™ silicone pad to fit ½ sheet pan
De-humidifying packet
Sealed storage container
   Exemplary Formula for Yogurt Coating for Vanilla Porous Interior Material With Internal Channel

Ingredient List—All ingredients are listed by weight unless otherwise noted and are at an ambient temperature of about 70° F., unless otherwise noted.

| | | | |
|---|---|---|---|
| 1 | Yogurt coating | 24 | oz |
| 2 | Crystal flakes | 2 | oz |

Procedure
Melt yogurt coating and crystal flake (1-2) over warm water (about 150° F.-160° F.) in large flat pan, sufficiently wide to accommodate 6 inch porous interior materials.
Roll the porous interior materials in prepare Yogurt coating until evenly coated.
Place coated porous interior material on SILPA™ baking pad and refrigerate to shock coating and harden it.
Thoroughly cool porous interior material until coating is fully hardened.
Store in cool location (under 70° F. ambient temperature), in a sealed container.
   Equipment Summary
Spatula
Heavy gauge aluminum baking sheet pans
Silicon tipped tongs (chocolate tongs)
Double boiler with wide pan
SILPA™ silicone pad to fit ½ sheet pan
Refrigerator at 34° F.
Sealed storage container
   Exemplary Formula for Dehydrated Meat Particle and Biscuit Porous Interior Material and Interstitial Space Core

Ingredient List—All ingredients are listed by weight unless otherwise noted and are at an ambient temperature of about 70° F., unless otherwise noted.

| | | | |
|---|---|---|---|
| 1 | Beef, Chicken or Fish, dehydrated | 8 | oz |
| 2 | Flour, whole wheat | 4.5 | oz |
| 3 | Flour, all-purpose | 5 | oz |
| 4 | Corn meal, medium grind | 1.25 | oz |
| 5 | Baking powder | .25 | tsp |
| 6 | Sugar, fine granulated | .75 | oz |
| 7 | Egg, whole shell | 1.75 | oz |
| 8 | Milk, whole | 5 | oz |
| 9 | Flour, whole wheat | 1 | oz |
| 10 | Egg white, liquid, lightly beaten | 2 | oz |

Procedure
Dice or shred dehydrated meat (1) into ⅛″×⅛″×½″ pieces.
Soft together 3 times all dry ingredients (2-6). Must be completely mixed.
Mix egg and milk (7-8) completely.
Make well in center of dry ingredients, and pour in liquid mixture.
Lift the dry mixture through liquid mixture until moist loose dough is formed. Do not knead or over mix and use dough immediately.
Very lightly flour (9) surface and rolling pin and roll out in a rectangle ⅛″ thick.
   Cut into 2″×6″ rectangles.
Lightly coat surface of rectangles with lightly beaten egg white.
Place ½ oz prepared meat along long center of a rectangle.
Roll rectangle into a tube with meat in center.
Gently pinch seam, being sure to seal edge.
Wash entire surface of tube with egg white.
Place on SILPAT™ in heavy gauge aluminum ½ sheet pan.
Place in 325° F. convection oven.
Bake for 6 minutes.
Remove and roll tubes over, exposing seam, and coat with beaten egg white.
Bake for 6 minutes.
Remove, roll tubes over, seam down, and coat with beaten egg white.
Bake for 6 more minutes, for a total baking time of 18 minutes.
Remove from oven and move rolls to rack until fully cooled.
   Equipment Summary
Scale
Mixing bowls—1 quart, 4 quart
Sifter
Knife
Cutting board
Spatula
Heavy gauge aluminum baking sheet pans
SILPAT™ baking pad
Oven—convection, dry
Cooling rack
Pastry brush
Rolling pin
Tongs

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A consumable food product adapted to enable a consumable liquid to be orally drawn into the food product and absorbed, comprising:
(a) consumable structural means for providing fluid communication between two spaced-apart points on a surface of the food product and for absorbing a consumable liquid that is drawn into the consumable structural means through one of the spaced-apart points when a partial vacuum is orally applied to the other of the spaced-apart points; and
(b) coating means that is consumable, for substantially sealing the surface of the consumable structural means, to substantially prevent free entry of air therein, except where the spaced-apart points are disposed.

2. A consumable food product adapted to enable a consumable liquid to be orally drawn into the food product and absorbed, comprising:
(a) an interior liquid-absorptive material that is consumable and which is formed so as to provide fluid communication between two spaced-apart points on a surface of the material; and
(b) a coating that is consumable and is applied to an outer surface of the interior liquid-absorptive material to substantially seal the liquid-absorptive material so as to substantially prevent free entry of air into the interior liquid-absorptive material, said consumable product thereby being adapted to enable a person to orally apply a reduced atmospheric pressure to one of the two spaced-apart points while the other of the two spaced-apart points is immersed in a consumable liquid, so that a consumable liquid is drawn into and absorbed by the interior liquid-absorptive material.

3. The food product of claim 2, wherein the interior liquid-absorptive material comprises at least one of:
(a) a channel that couples the two spaced-apart points in fluid communication;
(b) a plurality of open cells that are in fluid communication with each other; and
(c) a plurality of interstitial spaces that are in fluid communication.

4. The food product of claim 2, wherein the two spaced-apart points are not sealed by the coating, so that the outer surface of the interior liquid-absorptive material is accessible to fluid communication with a consumable liquid and the reduced atmospheric pressure at the two spaced-apart points.

5. The food product of claim 2, wherein the two spaced-apart points are sealed by the coating, which is removable by a person at the two spaced-apart points to provide fluid communication with a consumable liquid and the reduced atmospheric pressure.

6. The food product of claim 2, wherein the interior liquid-absorptive material comprises a granular material having interstitial spaces formed between grains that are absorptive of a consumable liquid to which the material is exposed.

7. The food product of claim 2, wherein the interior liquid-absorptive material comprises a dehydrated protein structure that is absorptive of the consumable liquid to which the dehydrated protein structure is exposed.

8. The food product of claim 2, wherein the interior liquid-absorptive material comprises a plurality of dehydrated meat particles having interstitial spaces formed between the plurality of dehydrated meat particles that is absorptive of the consumable liquid to which the plurality of dehydrated meat particles are exposed.

9. The food product of claim 2, wherein the interior liquid-absorptive material comprises a carbohydrate structure that is baked and relatively dry before being exposed to a consumable liquid, thereafter becoming wetted by a consumable liquid to which it is exposed.

10. The food product of claim 2, wherein the coating is resistant to dissolving in a consumable liquid.

11. The food product of claim 2, wherein the coating does not become tacky when exposed to a consumable liquid for a time sufficient to orally draw the consumable liquid into the interior liquid-absorptive material.

12. The food product of claim 2, wherein the interior liquid-absorptive material includes a channel formed between the two spaced-apart points so that a consumable liquid drawn into the channel is exposed to the material and is thereby absorbed into the material.

13. The food product of claim 2, wherein the coating includes a food flavoring selected to provide a desired flavor for the food product when consumed.

14. A method for producing a consumable food product, wherein the consumable food product enables a consumable liquid to be orally drawn into and absorbed by the food product, comprising the steps of:
(a) producing an internal structure that is consumable and formed so as to provide fluid communication between two spaced-apart points on a surface of the structure; and
(b) substantially sealing an outer surface of the structure with a layer that is consumable, to substantially prevent free entry of air into the structure, to enable a person to orally apply a reduced atmospheric pressure to one of the two spaced-apart points while the other of the two spaced-apart points is immersed in a consumable liquid, so that a consumable liquid is drawn into and absorbed by the structure.

15. A method for creating a consumable food product that enables a consumable liquid to be orally drawn into and absorbed by the food product, comprising the steps of:
(a) producing a liquid-absorptive material that is consumable and formed so as to provide fluid communication between two spaced-apart points on a surface of the material; and
(b) substantially sealing an outer surface of the liquid-absorptive material with a coating that is consumable, to substantially prevent free entry of air into the liquid-absorptive material, to enable a person to orally apply a reduced atmospheric pressure to one of the two spaced-apart points while the other of the two spaced-apart points is immersed in a consumable liquid, so that a consumable liquid is drawn into and absorbed by the interior liquid-absorptive material.

16. The method of claim 15, further comprising the step of forming a channel coupling the two spaced-apart points in fluid communication within the interior liquid-absorptive material.

17. The method of claim 15, wherein the interior liquid-absorptive material includes at least one of:
(a) a plurality of open cells that are in fluid communication with each other; and
(b) a plurality of interstitial spaces that are in fluid communication.

18. The method of claim 15, wherein the step of sealing further comprises the step of preventing the coating from sealing the two spaced-apart points, so that the outer surface of the interior liquid-absorptive material is accessible to fluid communication with a consumable liquid and the reduced atmospheric pressure at the two spaced-apart points.

19. The method of claim 15, further comprising the step removing the coating covering the two spaced-apart points, so that the outer surface of the interior liquid-absorptive material is accessible to fluid communication with a consumable liquid and the reduced atmospheric pressure at the two spaced-apart points.

20. The method of claim 15, wherein the coating is characterized by its resistance to dissolving in the consumable liquid.

21. The method of claim 15, wherein an exterior of the coating is characterized by its resistance to becoming tacky during use.

22. The method of claim 15, wherein the outer surface of the liquid-absorptive material is kept clean to enable the coating to more readily adhere to the outer surface.

23. The method of claim 15, wherein the outer surface of the liquid-absorptive material is coated to help the liquid-absorptive material adhere to another absorptive material.

24. The method of claim 15, wherein the liquid-absorptive material comprises a carbohydrate structure that is baked.

25. The method of claim 24, wherein an increase in a fiber content of a flour that comprises the carbohydrate structure is necessary to achieve stability.

26. The method of claim 15, wherein the liquid-absorptive material comprises a dehydrated meat particle structure.

27. A method for using a consumable food product that enables a consumable liquid to be orally drawn into and absorbed by the food product, comprising the steps of:
(a) positioning the consumable food product so that one of two spaced-apart points on a surface of the consumable food product is immersed in a consumable liquid; and
(b) orally applying a reduced atmospheric pressure to the other of the two spaced-apart points so that the consumable liquid is drawn into and absorbed by an interior material of the food product, without requiring that the consumable liquid be drawn into a user's mouth, so that the food product is enhanced by absorbing the consumable liquid.

28. The method of claim 27, further comprising the step of consuming the food product after it has absorbed the consumable liquid.

29. The method of claim 27, further comprising the step of removing a coating covering the two spaced-apart points, so that an outer surface of the interior material is accessible to fluid communication with the consumable liquid and with the reduced atmospheric pressure at the two spaced-apart points.

30. The method of claim 27, wherein the consumable liquid has a viscosity sufficiently low so that a user is able to draw the consumable liquid into the interior material by orally applying the reduced atmospheric pressure.

31. The method of claim 27, wherein the consumable food product is used to absorb one of:
(a) a beverage;
(b) a soup; and
(c) a sauce.
